(19) United States
(12) Patent Application Publication
(10) Pub. No.: US 2021/0063352 A1
(43) Pub. Date: Mar. 4, 2021

(54) Magnetic Transducer Using Hybrid Magnetic Matrix Core for Downhole Measurement Applications

(71) Applicant: GOWell International, LLC, Houston, TX (US)

(72) Inventors: Kuang Qin, Katy, TX (US); Jinsong Zhao, Houston, TX (US)

(73) Assignee: GOWell International, LLC, Houston, TX (US)

(21) Appl. No.: 16/551,371

(22) Filed: Aug. 26, 2019

(51) Int. Cl. G01N 27/90; E21B 47/00

(52) U.S. Cl. CPC G01N 27/9033; E21B 17/1078; E21B 47/00

(57) ABSTRACT

The present disclosure relates to embodiments of a device and method for inspecting and detecting characteristics of tubing and devices attached to tubing. More particularly, embodiments of a device and method are disclosed for inspecting a number of tube walls surrounding an innermost tube wall. In embodiments, an inspection device may induce an eddy current in surrounding tube walls by producing an electromagnetic field, wherein the induced eddy current may be recorded and analyzed for aberrations. Eddy currents may be produced by a sensor array comprising a hybrid magnetic matrix core capable of inducing an electromagnetic field at a high saturation point while maintaining good linearity. The eddy current decay and diffusion in the tube walls may be recorded, specifically recording voltage in embodiments, which may produce a function of the tube thickness and electromagnetic properties (e.g. metal conductivity and magnetic permeability) and the configurations of tubes.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Disclosure

This disclosure relates to a downhole tool that may be capable of detecting tubing thickness, free pipe, and/or casing resistivity. By detecting changes and variations of tubing walls an operator may be able to identify internal and/or external patches, clamps, corrosions, errosions, thickness, permeability, resitivity, and/or any combinations thereof.

### Background of the Disclosure

In oil production, tubing may be used in many different applications and may transport many types of fluids. Tubes may be conventionally placed underground and/or positioned in an inaccessible area, making inspection of changes within tubing difficult. It may be beneficial to measure the thickness variations within a tube while the tube is in use. Previous methods for inspecting tubes have come in the form of non-destructive inspection tools such as electromagnetic devices that may measure magnetic flux-leakage within tubing. However, such methods may not be able to detect changes in multi-pipe situations or perform multi-pipe azimuthal imaging. Further, the devices and methods that only measure flux-leakage may only be useful for the detection of localized damage in ferromagnetic pipes. The measurement of flux-leakage may also be hindered by the type of tube, thinning of tubing, the requirement of a strong magnetic field, the requirement of strong flux coupling, and the need for the device to be in close proximity to the tube walls.

Electromagnetic tools that use eddy current may be better suited for measuring the integrity of tubing. However, a drawback of a constant eddy current electromagnetic tool may be that the signal from several frequencies may not penetrate a first wall of tubing and allow inspection of the integrity of a second wall of a larger surrounding tubing. These transient electromagnetic methods using pulsed electromagnetic waves may be unable to increase the signals from a second tube wall to additional tube walls, may have problems optimizing a receiver coil, and may suffer “signal-to-noise ratio” problems. A further drawback of a constant eddy current electromagnetic tool is its inability to transmit a strong electromagnetic field with an applied current while maintaining linearity and sensitivity in measuring an induced voltage.

Consequently, there is a need for an improved electromagnetic tool that may be capable of transmitting a strong electromagnetic field, occurring at a high saturation point, and maintaining linearity properties that may allow for accurate evaluation of an induced voltage. An electromagnetic tool of this nature may more accurately detect and record multiple types of information and/or properties of multiple tubing in a wellbore.

### BRIEF SUMMARY OF SOME OF THE PREFERRED EMBODIMENTS

These and other needs in the art are addressed in one embodiment by a device for determining properties of tubing in a wellbore, wherein the tubing comprises one or more tubes, comprising an inspection system, a service device capable of raising and lowering the inspection system, a tether connecting the inspection system to the service device, and a housing capable of protecting the inspection system. The inspection system comprises a telemetry module, a centralizing module, and an inspection device. The inspection device comprises a memory module, a differential amplifier, and a sensor array. The sensor array comprises at least one transmitter coil array, at least one receiving coil array, and at least one hybrid magnetic matrix core.

These and other needs in the art are addressed in one embodiment by a method for determining properties of tubing in a wellbore, wherein the tubing comprises one or more tubes, comprising inserting an inspection system inside the tubing, applying a pulsed current to at least one transmitter coil array, and recoding induced voltage with at least one receiving coil array. The inspection system comprises a telemetry module, a centralizing module, and an inspection device. The inspection device comprises a memory module, a differential amplifier, and a sensor array. The sensor array comprises at least one transmitter coil array, the at least one receiving coil array, and the at least one hybrid magnetic matrix core.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an inspection system disposed downhole;

FIG. 2 illustrates an embodiment of a sensor array;

FIG. 3A illustrates a top view of an embodiment of a hybrid magnetic matrix core in a cylindrical shape;

FIG. 3B illustrates a side view of an embodiment of a hybrid magnetic matrix core in a cylindrical shape;

FIG. 4 illustrates an embodiment of a hybrid magnetic matrix core in a lamination shape;

FIG. 5 illustrates an embodiment of a hybrid magnetic matrix core in a tubular shape;

FIG. 6 is a graph illustrating the relationship between a magnetic field and an applied current for three different ferromagnetic core configurations; and

FIG. 7 is a graph illustrating the relationship between voltage and eddy currents for both a hybrid magnetic matrix core and a single core configuration.

### DETAILED DESCRIPTION OF THE PREFERRED EMBODIMENTS

The present disclosure relates to embodiments of a device and method for inspecting and detecting characteristics of tubing and devices attached to tubing. More particularly, embodiments of a device and method are disclosed for inspecting a number of tube walls surrounding an innermost tube wall. In embodiments, an inspection device may induce an eddy current in surrounding tube walls by producing an electromagnetic field, wherein the induced eddy current may be recorded and analyzed for aberrations. Eddy currents may be produced by a sensor array, which may be switched on and off to produce and record an induced eddy current in a tube and/or surrounding tube walls. The eddy current decay and diffusion in the tube walls may be recorded, specifically recording voltage in embodiments, which may produce a function of the tube thickness and electromagnetic properties (e.g. metal conductivity and magnetic permeability) and the configurations of tubes. In embodiments, the power provided to different sensors of the system may be the same or different.

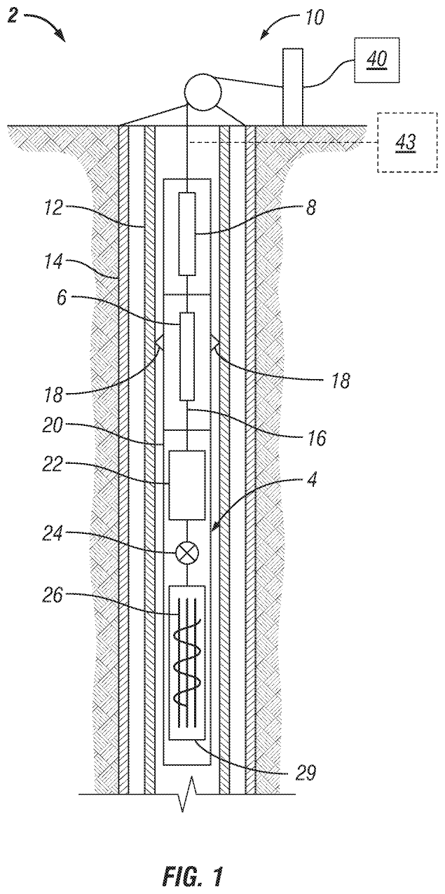

FIG. 1 illustrates an inspection system 2 comprising an inspection device 4, a centralizing module 6, and a telemetry module 8. In embodiments, inspection system 2 may be enclosed by a housing 20 capable of protecting and housing inspection device 4, centralizing module 6, and telemetry module 8. Housing 20 may be any suitable length, which may be about one foot to about ten feet, about four feet to about eight feet, about five feet to about eight feet, or about three feet to about six feet. Additionally, housing 20 may have any suitable width, which may be a diameter from about one foot to about three feet, about one inch to about three inches, about three inches to about six inches, about four inches to about eight inches, about six inches to about one foot, or about six inches to about two feet. Further, housing 20 may be made of any suitable material to resist corrosion and/or deterioration from a fluid. Suitable material may be, but is not limited to, titanium, stainless steel, plastic, and/or any combination thereof.

In embodiments, inspection system 2 may be inserted into a tubing 12 using a tether 16 and a service device 10. Tubing 12 may be a tube capable of transporting any type of fluid in a wellbore such as, without limitation, water, hydrocarbons, and the like. As illustrated, tubing 12 may be disposed within a casing 14. In further embodiments, not illustrated, there may be a plurality of casings 14, wherein tubing 12 may be contained by several additional casings 14. In embodiments, tubing 12 may be made of any suitable material for use in a wellbore. Suitable material may be, but is not limited to, metal, plastic, and/or any combination thereof. In some embodiments, there may be additional tubing which may encompass tubing 12.

Tether 16 may be any suitable cable that may support inspection system 2. A suitable cable may be steel wire, steel chain, braided wire, metal conduit, plastic conduit, ceramic conduit, and/or the like. A communication line, not illustrated, may be disposed within tether 16 and connect inspection device 4, centralizing module 6, and telemetry module 8 with service device 10. Without limitation, inspection system 2 may allow operators on the surface to review recorded data in real time from inspection device 4, centralizing module 6, and telemetry module 8.

Service device 10 may comprise a mobile platform (i.e. a truck) or stationary platform (i.e. a rig), which may be used to lower and raise inspection system 2. In embodiments, service device 10 may be attached to inspection system 2 by tether 16. Service device 10 may comprise any suitable equipment which may lower and/or raise inspection system 2 at a set or variable speed, which may be chosen by an operator. The movement of inspection system 2 may be monitored and recorded by telemetry module 8.

Telemetry module 8 may comprise any devices and processes for making, collecting, and/or transmitting measurements. For instance, telemetry module 8 may comprise an accelerometer, gyro, and the like. In embodiments, telemetry module 8 may operate to indicate where inspection system 2 may be disposed within tubing 12 and the orientation of a sensor array 26 (discussed below) which is disposed in inspection device 4. Telemetry module 8 may be disposed at any location above, below, and/or between centralizing module 6 and inspection device 4. In embodiments, telemetry module 8 may send information and/or data it has obtained from inspection device 4 through the communication line in tether 16 to a remote location such as a receiver or an operator in real time. This may allow an operator to know where inspection system 2 may be located within tubing 12, as well as various characteristics of tubing 12. Telemetry module 8 may be configured to fetch data from inspection device 4 at any suitable rate. In embodiments, the rate may range from about every 100 milliseconds (ms) to about every 1 second (s). Alternatively, the rate may be about every 200 ms. In addition to this longitudinal location in tubing 12, it may be beneficial to provide lateral positioning for inspection system 2.

Centralizing module 6 may be used to position inspection device 4 and/or telemetry module 8 inside tubing 12. In embodiments, centralizing module 6 laterally positions inspection device 4 and/or telemetry module 8 at about a center of tubing 12. Centralizing module 6 may be disposed at any location above and/or below telemetry module 8 and/or inspection device 4. In embodiments, centralizing module 6 may be disposed above inspection device 4 and below telemetry module 8. Further, centralizing module 6 may comprise arms 18. In embodiments, there may be a plurality of arms 18 that may be disposed at any location along the exterior of centralizing module 6. In an embodiment, as shown, at least one of arms 18 may be disposed on an opposing lateral side of centralizing module 6. Additionally, there may be at least three arms 18 disposed on the outside of centralizing module 6. Arms 18 may be moveable at a connection with centralizing module 6, which may allow inspection system 2 to be moved closer and farther away from the walls of tubing 12. Arms 18 may comprise any suitable material. Suitable material may be, but is not limited to, stainless steel, titanium, metal, plastic, rubber, neoprene, and/or any combination thereof. In embodiments, the addition of springs 19 (not illustrated) may further make up and/or be incorporated into centralizing module 6. Springs 19 may assist arms 18 in moving centralizing module 6 away from tubing 12, and thus inspection device 4 and telemetry module 8, to about the lateral center of tubing 12. Without limitation, centering inspection device 4 may produce more reliable and accurate voltage readings of tubing 12.

In embodiments, inspection device 4 may be disposed below centralizing module 6 and telemetry module 8. In other embodiments, not illustrated, inspection device 4 may be disposed above and/or between centralizing module 6 and telemetry module 8. Inspection device 4 may be able to detect defects, measure resistivity of tubing 12 and/or casing 14, detect free pipe, and/or measure wall thickness in tubing 12 and/or casing 14. In embodiments, inspection device 4 may be able to detect and/or locate transverse and longitudinal defects (both internal and external) and determine the deviation of the wall thickness from its nominal value through the interpretation of voltage data. Inspection device 4 may comprise a memory module 22, a differential amplifier 24, and sensor array 26. Housing 20 may protect memory module 22, differential amplifier 24, and sensor array 26 from the surrounding downhole environment within tubing 12.

As illustrated in FIG. 1, memory module 22 may be disposed within inspection device 4. In embodiments, memory module 22 may store all received, recorded, and measured data and may transmit the data in real time through a communication line in tether 16 to a remote location such as an operator on the surface. Memory module 22 may comprise flash chips and/or ram chips, which may be used to store data and/or buffer data communication. Additionally, memory module 22 may further comprise a transmitter, a processing unit, and/or a microcontroller. In embodiments, memory module 22 may be removed from inspection device 4 for further processing. Memory module 22 may be disposed within any suitable location of inspection device 4, such as about the top, about the bottom, or about the center. In embodiments, memory module 22 may be in communication with differential amplifier 24 and sensor array 26 by any suitable means such as a connection via communication line, similar to that in tether 16. Further, memory module 22 may store voltage recordings transmitted from differential amplifier 24.

Differential amplifier 24 may be disposed within inspection device 4. In embodiments, differential amplifier may control the amplitude and phase of transmitter coil array 34, the amplifier factor, and the signal acquiring period of receiving coil array 32 (discussed below). Additionally, differential amplifier 24 may be pre-configured at the surface to take into account the downhole logging environment and specific logging cases. It may also be dynamically configured by what a receiver may record. Differential amplifier 24 may be disposed at any suitable location within inspection device 4. In embodiments, such disposition may be about the top, about the bottom, or about the center of inspection device 4. In addition to differential amplifier 24, sensory array 26 is also disposed in inspection device 4.

In embodiments, sensor array 26 may create an electromagnetic field, which may induce an eddy current in surrounding tubing 12 and/or casing 14. The voltage charge within tubing 12 and/or casing 14, from the induced eddy current, may be sensed and recorded by sensor array 26. In embodiments, the recorded voltage may allow identification of the characteristics of tubing 12 and/or casing 14. Sensor array 26 may be disposed within a sensor array housing 29. Sensor array housing 29 may be composed of any suitable non-ferrous material such as plastic, ceramic, and the like. In embodiments, sensor array 26 may be disposed in a fluid within sensor array housing 29. This may prevent sensor array 26 from moving during operations and further protect sensor array 26 from subsurface pressure. Sensor array 26 may be disposed at any suitable location within inspection device 4. Such disposition may be at about the top, about the bottom, or about the center of inspection device 4. Additionally, there may be a plurality of sensor arrays 26 disposed throughout sensor array housing 29.

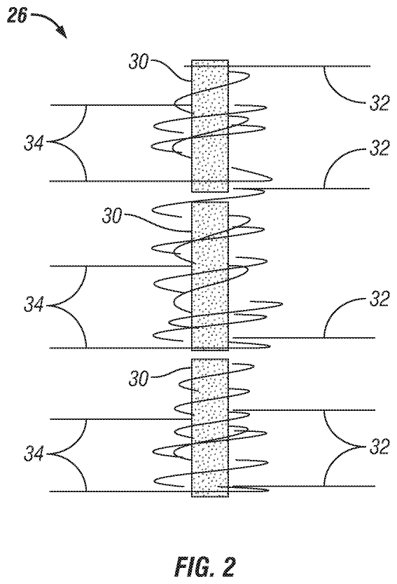

As illustrated in FIG. 2, sensor array 26 may comprise at least one transmitter coil array 34, at least one receiving coil array 32, and at least one hybrid magnetic matrix core 30. In embodiments, transmitter coil array 34, may be a wire wrapped around hybrid magnetic matrix core 30 and receiving coil array 32. Transmitter coil array 34 may comprise any suitable material. Suitable material may be, but is not limited to, aluminum, copper, nickel, steel, and/or any combination thereof. Further, transmitter coil array 34 may be any suitable length. A suitable length may be, but is not limited to, about one inch to about three inches, about two inches to about four inches, about three inches to about six inches, about four inches to about eight inches, about five inches to about ten inches, or about six inches to about twelve inches. Transmitter coil array 34 may be longer than hybrid magnetic matrix core 30. Additionally, transmitter coil array 34 may be any suitable shape. A suitable shape may be, but is not limited to, round, oval, square, triangular, polyhedral, and/or any combination thereof. Without limitation, transmitter coil array 34 may comprise any number of suitable windings. In embodiments, transmitter coil array 34 may eliminate coupling power between transmitter coil array 34 and receiving coil array 32. This may be accomplished as each hybrid magnetic matrix core 30 may transmit magnetic flux with transmitter coil array 34. The magnetic flux may be directed in the same direction due to each hybrid magnetic matrix core 30, which may eliminate individual magnetic flux loops. Transmitter coil array 34 may also boost the power associated with the production of an electromagnetic field. This may increase the distance in which the electromagnetic field may extend from sensor array 26. During operation, transmitter coil array 34 may be energized with a pulsed current to produce an electromagnetic field through hybrid magnetic matrix core 30, which may induce an eddy current in tubing 12 and/or casing 14. The pulse current may range from about 200 milliamps (mA) to about 2 amps (A). Alternatively, the pulse current may range from about 200 mA to about 500 mA (low pulse). Alternatively, the pulse current may range from about 1 A to about 2 A (high pulse). A microprocessor and/or a controller unit that may be disposed in memory module 22 may be used to direct current into and out of transmitter coil array 34.

As is further illustrated in FIG. 2, receiving coil array 32 may be a wire wrapped around the at least one hybrid magnetic matrix core 30 and transmitter coil array 34. In embodiments, receiving coil array 32 may comprise any suitable material. Suitable material may be, but is not limited to, aluminum, copper, nickel, steel, and/or any combination thereof. Receiving coil array 32 may be any suitable length. A suitable length may be, but is not limited to, about one inch to about three inches, about two inches to about four inches, about three inches to about six inches, about four inches to about eight inches, about five inches to about ten inches, or about six inches to about twelve inches. Receiving coil array 32 may be longer than hybrid magnetic matrix core 30. Receiving coil array 32 may be any suitable shape. A suitable shape may be, but is not limited to, round, oval, square, triangular, polyhedral, and/or any combination thereof. Without limitation, receiving coil array 32 may comprise any number of suitable windings. Receiving coil array 32 may sense voltage from the emitted electromagnetic field as originally transmitted by transmitter coil array 34. The difference in the voltages measured from tubing 12 by sensor array 26 may be used to identify characteristics of tubing 12 and/or casing 14. Additionally, the microprocessor that may be disposed in memory module 22 may be used to record and transmit the recorded voltages within receiving coil array 32.

In embodiments, hybrid magnetic matrix core 30 may be a medium in which an electromagnetic field induced by transmitter coil array 34 is broadened, which may induce an eddy current within tubing 12 and/or casing 14. In embodiments, hybrid magnetic matrix core 30 may be a structure in which receiving coil array 32 and transmitter coil array 34 may be disposed on. Further, hybrid magnetic matrix core 30 may comprise any suitable material. Suitable material may be, but is not limited to, ferrite, silicon steel, nickel steel, alloy powder, permalloy, supermalloy, mu-metal and/or any combination thereof. Hybrid magnetic matrix core 30 may be any suitable length. A suitable length may be, but is not limited to, about one inch to about three inches, about two inches to about four inches, about three inches to about six inches, about four inches to about eight inches, about five inches to about ten inches, or about six inches to about twelve inches. In embodiments, hybrid magnetic matrix core 30 may be shorter than transmitter coil array 34 and/or receiving coil array 32. Alternatively, hybrid magnetic matrix core 30 may be longer that transmitter coil array 34 and/or receiving coil array 32. Hybrid magnetic matrix core 30 may be any suitable shape. A suitable shape may be, but is not limited to, round, oval, square, triangular, polyhedral, and/or any combination thereof. Additionally, hybrid magnetic matrix core 30 may be configured in any suitable structure in which to transmit an electromagnetic field to and through tubing 12 and/or casing 14. The electromagnetic field may be transmitted, directed, and focused within a desired area by hybrid magnetic matrix core 30. Without limitation, structures of hybrid magnetic matrix core 30 may vary in both shape and composition. For instance, in regards to shape, a hybrid magnetic matrix core may be, without limitation, dumbbell-shaped, hammer-shaped, side tapered, and/or center tapered. Each core structure may produce a different type of electromagnetic field. A dumbbell-shaped hybrid magnetic matrix core 30 may focus and/or guide the electromagnetic field horizontally to a desired depth. A hammer-shaped hybrid magnetic matrix core 30 may block magnetic interference from an end of hybrid magnetic matrix core 30. A tapered shaped hybrid magnetic matrix core 30 may reduce motion noise. A center tapered hybrid magnetic matrix core 30 may focus the electromagnetic field about the center of hybrid magnetic matrix core 30. In regards to composition, a hybrid magnetic matrix core 30 may comprise a cluster of multiple ferromagnetic materials capable of producing different types of electromagnetic fields. In embodiments hybrid magnetic matrix core 30 may comprise a combination of silicon steel and mu-metal. Alternatively, hybrid magnetic matrix core may comprise a combination of silicon steel, mu-metal, and permalloy. Hybrid magnetic matrix core 30 may be configured in such a way as to transmit and/or produce a strong electromagnetic field with a high magnetic saturation point from about 1 tesla (T) to about 3 T while maintaining linearity properties. Alternatively, the high magnetic saturation point may be from about 1.6 T to about 2.2 T while still maintaining linearity properties.

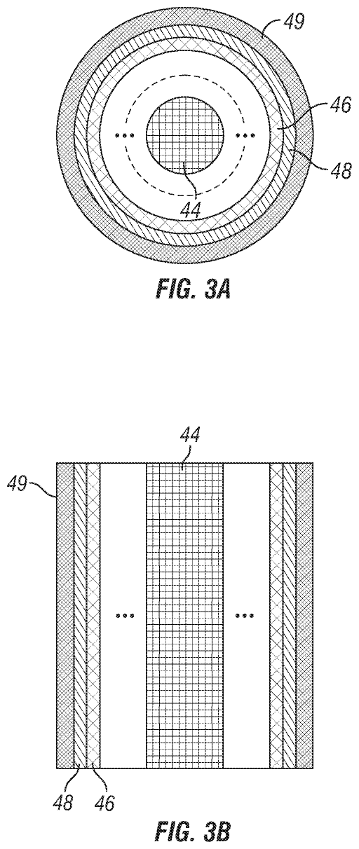

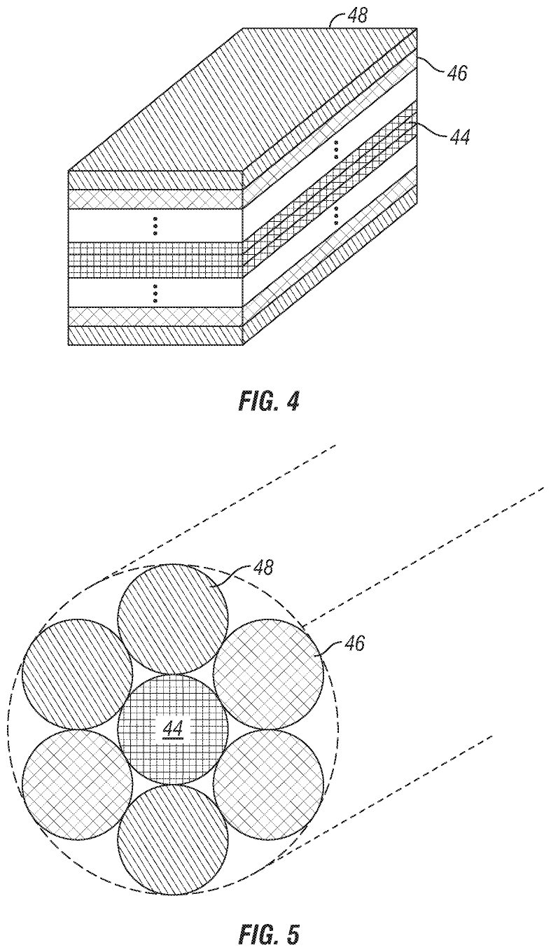

FIGS. 3-5 illustrate examples of hybrid magnetic matrix core 30 consisting of various shapes and compositions. FIGS. 3A and 3B show hybrid magnetic matrix core 30 in a cylindrical shape with a composition of various ferromagnetic metals, FIG. 4 shows hybrid magnetic matrix core in a lamination shape with a composition of various ferromagnetic metals, and FIG. 5 shows hybrid magnetic matrix core 30 in a tubular shape with a composition of various ferromagnetic metals. Each shape may produce a different electromagnetic field that may be desired by an operator. Further, the ferromagnetic metals may be place in any configuration, any order, or in any amount to achieve any desired electromagnetic field. Additionally, FIGS. 3-5 illustrate examples of hybrid magnetic matrix core 30 comprising a first ferromagnetic metal 44, a second ferromagnetic metal 46, and a last ferromagnetic metal. Second ferromagnetic metal 46 may be any number of metals of any type. Receiving coil array 32 and transmitter coil array 34 are disposed about about last ferromagnetic metal 48, illustrated by area 49.

As discussed above, an electromagnetic field may be produced and emitted from sensor array 26. In embodiments, an electromagnetic field may need to be strong and large enough to induce an eddy current in a second tube and/or a second casing (not illustrated). Without limitation, an electromagnetic field may be able to induce an eddy current into a fifth casing and may be up to three feet into a formation. In embodiments, transmitter coil array 34 may be turned off and on at any given length of time. When turned on, the transmitter coil array 34 may produce an electromagnetic field, which may be directed by hybrid magnetic matrix core 30 and induce eddy current in tubing 12 and/or casing 14. Transmitter coil array 34 may then be switched off, which may allow for receiving coil array 32 to sense and record the voltage produced by the induced eddy current. In embodiments, different configurations of hybrid magnetic matrix core 30 may direct the electromagnetic field differently. These configurations may be selected by an operator in such a way as to achieve accurate measurements on tubing 12 and/or casing 14, particularly those far from the center of a wellbore. This may be done using hybrid magnetic matrix core 30 capable of producing a strong electromagnetic field with a high saturation point and linearity properties. A strong electromagnetic field with a high saturation point may allow transmitter coil array 34 to transmit an electromagnetic field capable of reaching tubing 12 and/or casing 14 to induce an eddy current, particularly for embodiments in which tubing 12 and casing 14 comprise multiple tube and casing layers. Additionally, linearity may demonstrate a relationship between an applied current and magnetic permeability, therefore allowing accurate evaluation of an induced voltage in tubing 12 and/or casing 14. Accurate evaluation may identify internal and/or external patches, clamps, corrosions, errosions, thickness, permeability, resitivity, and/or any combination thereof.

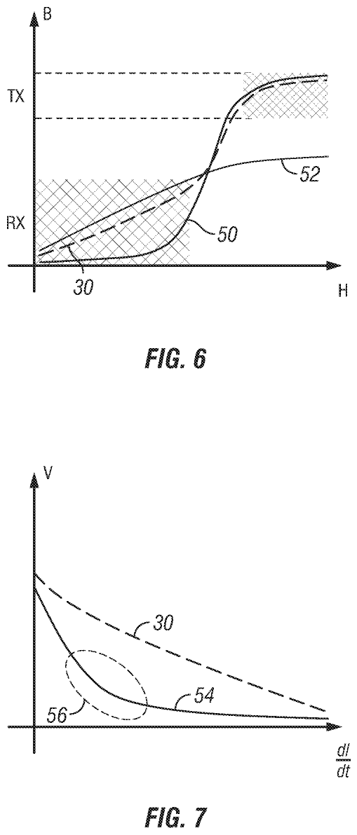

In an embodiment in which sensor array 26 comprises a core with a single ferromagnetic material, transmitter coil array 34 may transmit a strong electromagnetic field with a high saturation point, but the field may be lacking the linearity needed to determine the properties of tubing 12 and/or casing 14. Alternatively, transmitter coil array 34 may transmit an electromagnetic field with the necessary linearity, but the field may be lacking a high saturation point capable of reaching tubing 12 and/or casing 14, particularly those far from the center of a wellbore. This idea is more greatly illustrated in FIG. 6.

FIG. 6 illustrates an example of the effect of using hybrid magnetic matrix core 30 over stand-alone ferromagnetic cores. The graph illustrates the relationship between magnetic field and applied current. A first material 50 may be silicon steel while a second material 52 may be nickel steel. First material 50, according to FIG. 6, may be capable of transmitting a strong electromagnetic field due to a high saturation point. However, reception of the electromagnetic field lacks the linearity to provide accurate evaluation of received measurements. Conversely, an electromagnetic field of second material 52 comprises linearity, but does not comprise a high saturation point. As illustrated in FIG. 6, using hybrid magnetic matrix core 30, an operator may achieve transmission of a strong electromagnetic field with both a high saturation point and linearity properties. In regards to transmission of the electromagnetic field, hybrid magnetic matrix core 30 performs like first material 50, wherein a higher electromagnetic field may be achieved given the same excitation current. Additionally, in regard to reception, hybrid magnetic matrix core 30 performs like second material 52, wherein a higher induced electromotive force (voltage) from Lenz's Law formula may be achieved given the same change in eddy current.

FIG. 7 further illustrates this relationship between voltage and change in eddy currents. The graph illustrates the improved linearity in receiving coil array 32 when sensor array 26 comprises hybrid magnetic matrix core 30 versus a single core configuration 54. Single core configuration 54 comprises nonlinear section 56.

Measurements, inspections, and detection may take place as inspection system 2 moves through tubing 12 in any direction. Inspection system 2 may travel from the bottom of tubing 12 to the top of tubing 12, or alternatively, from the top of tubing 12 to the bottom of tubing 12. Further, inspection system 2 may travel through tubing 12 entirely, or alternatively, may travel through only a portion of tubing 12 at a zone of interest. Inspection system 2 may perform any suitable number of logs on tubing 12 with any desired configurable logging speed. Logging speed of inspection system 2 in tubing 12 may depend on the duration of pulses and amplitude used to produce and transmit an electromagnetic field through inspection device 4. In embodiments, the logging speed may range from about 5 feet per minute (fpm) to about 30 fpm. Duration of a pulse may be set so that the signal variation between the excitation time and the “infinite” excitation time may be less than the noise constantly detected at signal level. Duration may vary based on the “electromagnetic” wall thickness of tubing 12. Electromagnetic wall thickness refers to the given conductivity and relative permeability with tubing 12 thickness. The electromagnetic field created by the pulse may be used to induce an eddy current in tubing 12 and/or additional tubing. Additionally, hybrid magnetic matrix core 30 may allow for inspection device 4 to transmit an electromagnetic field three hundred and sixty degrees, which may allow inspection device 4 to inspect the entirety of tubing 12, surrounding tubes, and/or casing 14. In embodiments, a single log may provide a normalized voltage, a depth measurement of inspection device 4, a thickness estimation of tubing 12, and a rough sketch of the well.

In embodiments, signals recorded by receiving coil array 32 may be processed using information handling system 40. Referring to FIG. 1, information handling system 40 may be disposed within inspection system 2 at any location. Without limitation, information handling system 40 may also be disposed on the surface within service device 10. Processing may take place within information handling system 40 within inspection device 4 and/or on the surface in service device 10. Information handling system 40 within inspection device 4 may connect to service device 10 through waveguide 43, which may be disposed within tether 16. It is to be understood that waveguide 43, as shown disposed in FIG. 1 for illustration purposes only, may be disposed within tether 16. Information handling system 40 may act as a data acquisition system and possibly a data processing system that analyzes signals from receiving coil array 32, for example, to derive one or more properties of tubing 12 and/or casing 14.

Without limitation in this disclosure, information handling system 40 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, information handling system 40 may be a personal computer, a network storage device, or any other suitable device and may vary in size, shape, performance, functionality, and price. Information handling system 40 may include random access memory (RAM), one or more processing resources such as a central processing unit (CPU) or hardware or software control logic, ROM, and/or other types of nonvolatile memory. Additional components of information handling system 40 may include one or more disk drives, one or more network ports for communication with external devices as well as various input and output (I/O) devices, such as a keyboard, a mouse, and a video display. Information handling system 40 may also include one or more buses operable to transmit communications between the various hardware components.

Certain examples of the present disclosure may be implemented at least in part with non-transitory computer-readable media. For the purposes of this disclosure, non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Although the present invention and its advantages have been described in detail, it should be understood that various changes, substitutions and alterations may be made herein without departing from the spirit and scope of the invention as defined by the appended claims.

What is claimed is:

1. A device for determining properties of a plurality of tubing and a plurality of casing in a wellbore comprising:
an inspection system, wherein the inspection system comprises:
a telemetry module;
a centralizing module; and
an inspection device, wherein the inspection device comprises:
a memory module;
a differential amplifier; and
a sensor array, wherein the sensor array comprises:
at least one transmitter coil array;
at least one receiving coil array; and
at least one hybrid magnetic matrix core;
a service device, wherein the service device raises and lowers the inspection system into the wellbore;
a tether, wherein the tether connects the inspection system to the service device; and
a housing, wherein the housing is capable of protecting all components of the inspection system.

2. The device of claim 1, wherein the at least one transmitter coil array and the at least one receiving coil array are disposed about the at least one hybrid magnetic matrix core.

3. The device of claim 1, wherein the at least one hybrid magnetic matrix core is a medium in which an electromagnetic field induced by the at least one transmitter coil array is broadened.

4. The device of claim 3, wherein the electromagnetic field comprises a high saturation point, linearity, or combinations thereof.

5. The device of claim 3, wherein the electromagnetic field expands through multiple tubes and casings disposed in the wellbore.

6. The device of claim 1, wherein the at least one hybrid magnetic matrix core comprises a composition of ferromagnetic materials.

7. The device of claim 4, wherein the ferromagnetic materials comprise ferrite, silicon steel, nickel steel, alloy powder, permalloy, supermalloy, mu-metal or any combinations thereof.

8. The device of claim 4, wherein the ferromagnetic materials are disposed together in any order.

9. The device of claim 1, wherein the at least one hybrid magnetic matrix core has a length between about 1 inch and about 12 inches.

10. The device of claim 1, wherein the at least one hybrid magnetic matrix core is a cylindrical shape, lamination shape, tubular shape, or any combinations thereof.

11. A method for determining properties of a plurality of tubing and a plurality of casing in a wellbore comprising:
inserting an inspection system inside the inner-most tubing or casing, wherein the inspection system comprises:
a telemetry module;
a centralizing module; and
an inspection device, wherein the inspection device comprises:
a memory module;
a differential amplifier; and
a sensor array, wherein the sensor array comprises:
at least one transmitter coil array;
at least one receiving coil array; and
at least one hybrid magnetic matrix core;
applying a pulsed current to the at least one transmitter coil array; and
recording an induced voltage with the at least one receiving coil array.

12. The method of claim 1, wherein the at least one transmitter coil array and the at least one receiving coil array are disposed about the at least one hybrid magnetic matrix core.

13. The method of claim 1, wherein the at least one hybrid magnetic matrix core is a medium in which an electromagnetic field induced by the at least one transmitter coil array is broadened.

14. The method of claim 3, wherein the electromagnetic field comprises a high saturation point, linearity, or combinations thereof.

15. The method of claim 3, wherein the electromagnetic field expands through multiple tubes and casings disposed in the wellbore.

16. The method of claim 1, wherein the at least one hybrid magnetic matrix core comprises a composition of ferromagnetic materials.

17. The method of claim 4, wherein the ferromagnetic materials comprise ferrite, silicon steel, nickel steel, alloy powder, permalloy, supermalloy, mu-metal or any combination thereof.

18. The method of claim 4, wherein the ferromagnetic materials are disposed together in any order.

19. The method of claim 1, wherein the at least one hybrid magnetic matrix core has a length between about 1 inch and about 12 inches.

20. The method of claim 1, wherein the at least one hybrid magnetic matrix core is a cylindrical shape, lamination shape, tubular shape, or any combinations thereof.
